(19) United States
(12) Patent Application Publication
(10) Pub. No.: US 2008/0055474 A1
(43) Pub. Date: Mar. 6, 2008

(54) Projection apparatus and an automatic image adjustment method thereof

(75) Inventors: Jung-Chi Chen, Hsinchu (TW); Che-Hsueh Chen, Hsinchu (TW)

Correspondence Address: DAVIDSON BERQUIST JACKSON & GOWDEY LLP, 4300 WILSON BLVD., 7TH FLOOR, ARLINGTON, VA, 22203, US

(73) Assignee: CORETRONIC CORPORATION, Hsinchu (TW)

(21) Appl. No.: 11/878,389

(22) Filed: Jul. 24, 2007

(30) Foreign Application Priority Data
Sep. 6, 2006 (TW) 095132872

(51) Int. Cl. H04N 9/74

(52) U.S. Cl. 348/580

(57) ABSTRACT

A projection apparatus includes a projection unit, an image processing unit, and a detection module. The projection unit receives an image output signal, and converts the image output signal into an image light beam for projecting a projection image. The detection module detects a placement orientation of the projection apparatus, and generates a placement signal according to the placement orientation detected thereby. The image processing unit is coupled to the projection unit and the detection module, and generates the image output signal to the projection unit. The image processing unit receives an image source signal, and adjusts the image source signal to result in the image output signal such that the projection image corresponding to the image output signal is rotated by a predetermined angle. The projection apparatus automatically detects the placement orientation and corrects the angle of the projection image, and user manual setting is no longer required.

### CROSS-REFERENCE TO RELATED APPLICATION

This application claims priority of Taiwanese Application No. 095132872, filed on Sep. 6, 2006.

### BACKGROUND OF THE INVENTION

1. Field of the Invention

The invention relates to a projection apparatus and a control method thereof. More particularly, the invention relates to a projection apparatus and a method of automatic image adjustment thereof.

2. Description of the Related Art

As shown in FIG. 1, when a conventional projection apparatus 9 is placed upstanding on a table, where a securing part 91 thereof is disposed on the table top, a projection image 901 projected by the conventional projection apparatus 9 is upright, which is the ideal orientation for viewing of the projection image 901 by a user. As shown in FIG. 2, when the conventional projection apparatus 9 is hung from a ceiling, where the securing part 91′ is mounted to the ceiling, the projection image 901′ projected by the conventional projection apparatus 9 is upside-down. Therefore, the user needs to adjust relevant control settings according to the actual placement orientation (i.e., upstanding or upturned) of the conventional projection apparatus 9 in order to display a projection image 901 with the ideal upright orientation. At present, the user makes this adjustment by adjusting a signal source function setting in an onscreen display (OSD) control selection menu. However, this kind of manual adjustment is required each time the conventional projection apparatus 9 is oriented differently, which is troublesome and time consuming.

### SUMMARY OF THE INVENTION

Therefore, the object of the present invention is to provide a projection apparatus capable of automatic image adjustment according to detected placement orientation of the projection apparatus in order to save time and trouble.

Another object of the present invention is to provide a method of automatic image adjustment for a projection apparatus, where the adjustments are automatically made according to detected placement orientation of the projection apparatus.

According to one aspect of the present invention, there is provided a projection apparatus that includes a projection unit, an image processing unit, and a detection module. The projection unit receives an image output signal, and converts the image output signal into an image light beam for projecting a projection image. The detection module detects a placement orientation of the projection apparatus, and generates a placement signal according to the placement orientation detected thereby. The image processing unit is coupled to the projection unit and the detection module, and generates the image output signal to the projection unit. The image processing unit is for receiving an image source signal, and adjusts the image source signal according to the placement signal to result in the image output signal such that the projection image corresponding to the image output signal is rotated from an initial orientation by a predetermined angle.

According to another aspect of the present invention, there is provided a method of automatic image adjustment for a projection apparatus. The method includes the steps of: (A) detecting placement orientation of the projection apparatus and generating a placement signal according to the placement orientation thus detected; (B) adjusting an image source signal according to the placement signal to result in an image output signal such that a projection image corresponding to the image output signal is rotated from an initial orientation by a predetermined angle; and (C) converting the image output signal into an image light beam and projecting a projection image accordingly.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional projection apparatus placed on a table top;

FIG. 2 is a schematic view of the conventional projection apparatus hung from a ceiling;

FIG. 3 is a system block diagram of the first preferred embodiment of a projection apparatus according to the present invention;

FIG. 4 is a block diagram of a detection module according to the first preferred embodiment;

FIG. 5 is a schematic diagram of a detection module according to the second preferred embodiment of a projection apparatus according to the present invention; and

FIG. 6 is a flow chart illustrating the method for automatic image adjustment according to the preferred embodiment of the present invention.

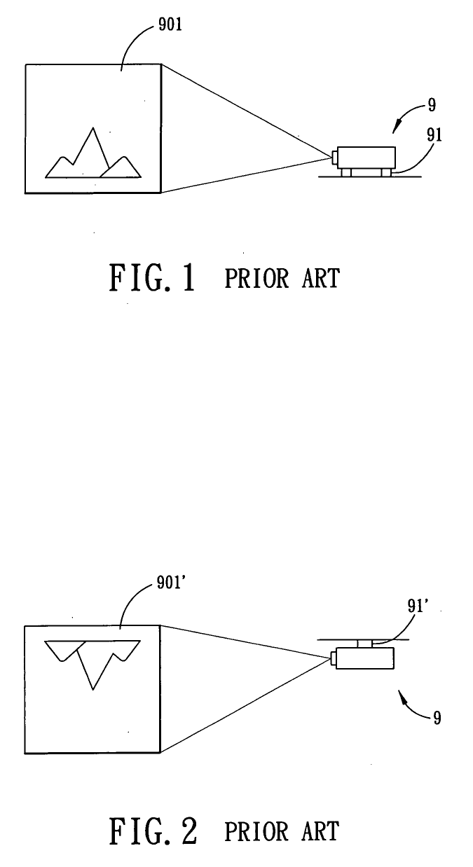

### DETAILED DESCRIPTION OF THE PREFERRED EMBODIMENTS

It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “coupled,” and variations thereof herein are used broadly and encompass direct and indirect connections, couplings, and mountings.

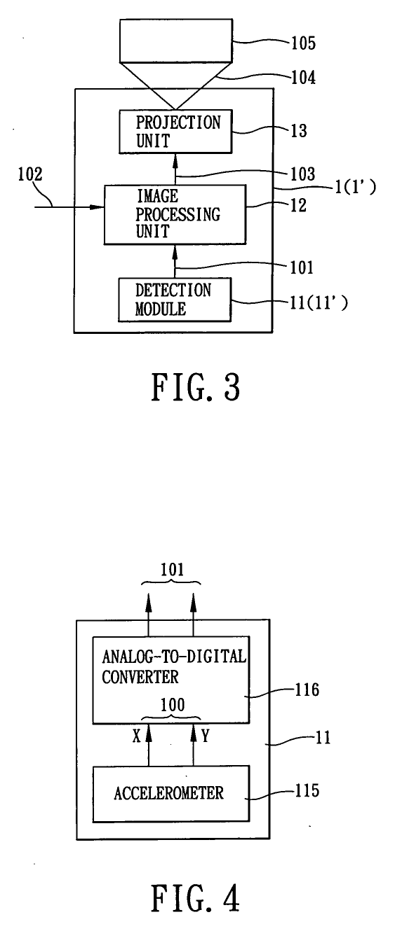

As shown in FIG. 3, the first preferred embodiment of a projection apparatus 1 according to the present invention includes a projection unit 13, an image processing unit 12, and a detection module 11. The projection unit 13 receives an image output signal 103, and converts the image output signal 103 into an image light beam 104 for projecting a projection image 105. The detection module 11 detects a placement orientation of the projection apparatus 1, and generates a placement signal 101 according to the placement orientation detected thereby. In particular, the placement orientation of the projection apparatus 1 includes an upstanding orientation and an upturned orientation in this embodiment. The detection module 11 generates a different placement signal 101 for each of the upstanding and upturned orientations. The detection module 11 is implemented in various ways, which will be described in detail in the succeeding paragraphs. The image processing unit 12 is coupled to the projection unit 13 and the detection module 11, and generates the image output signal 103 to the projection unit 13. The image processing unit 12 for receiving the placement signal 101. The image processing unit 12 receives an image source signal 102, and adjusts the image source signal 102 according to the placement signal 101 to result in the image output signal 103 such that the projection image 105 corresponding to the image output signal 103 is rotated from an initial orientation by a predetermined angle.

As shown in FIG. 3 and FIG. 4, the detection module 11 according to the first preferred embodiment of the present invention includes an accelerometer 115 and an analog-to-digital (A/D) converter 116 connected electrically to the accelerometer 115 and the image processing unit 12. The accelerometer 115 detects the placement orientation of the projection apparatus 1 in terms of angular rotation relative to a pair of axes (X,Y) that are perpendicular to each other, and generates an analog signal 100, which includes X and Y components respectively. The analog-to-digital converter 116 receives the analog signal 100 from the accelerometer 115, and digitizes the analog signal 100 to result in the placement signal 101 that is outputted to the image processing unit 12. The accelerometer 115 is model no. MXD2020E manufactured by MEMSIC Inc. The detection module 11 that incorporates the accelerometer 115 is capable of generating a unique placement signal 101 for each angular placement orientation of the projection apparatus 1 detected. The image source signal 102 is adjusted to result in the image output signal 103 such that, for each different placement signal 101, the projection image 105 corresponding to the image output signal 103 is rotated from the initial orientation by a different predetermined angle. The predetermined angle can range between 0 to 180 degrees. Therefore, when the projection apparatus 1 is oriented randomly (not limited to the upstanding and upturned orientations), orientation of the resultant projection image 105 is adjusted suitably based on the placement orientation of the projection apparatus 1 as detected by the accelerometer 115. Other than the detection scheme shown in FIG. 4, the detection module 11 is also a tilt switch or a rotary detecting switch in other embodiments of the present invention. However, since operating principles for these detection schemes are known in the art, further details of the same are omitted herein for the sake of brevity.

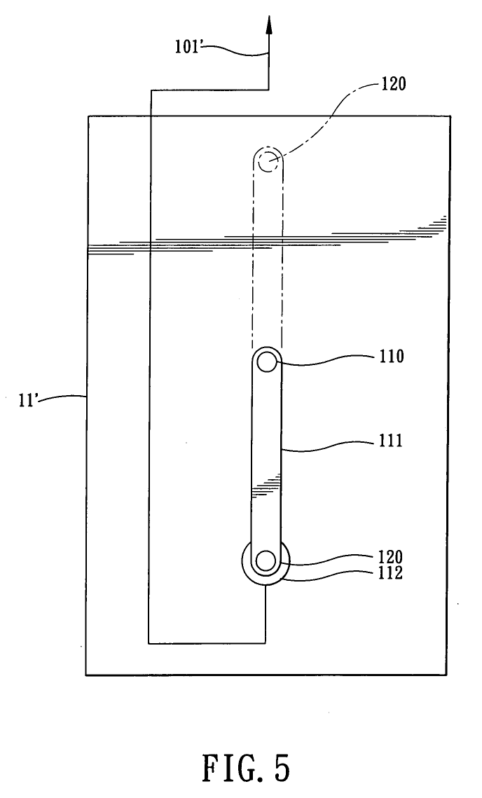

As shown in FIG. 3 and FIG. 5, the second preferred embodiment of a projection apparatus 1′ according to the present invention differs from the first preferred embodiment in the detection module 11′. The detection module 11′ of the second preferred embodiment includes a gravitation rod 111. The gravitation rod 111 has first and second ends 110, 120 opposite to each other. The gravitation rod 111 has a first end 110 serving as a pivot, and a second end 120 moving around the first end 110 according to change of the placement orientation of the projection apparatus 1′ such that the second end 120 electrically connects to or disconnects from an electrical terminal 112 so as to generate the placement signal 101′ accordingly. In particular, when the projection apparatus 1′ (refer to FIG. 3) is placed on a table top, i.e., in the upstanding orientation, the second end 120 of the gravitation rod 111 is connected electrically to the electrical terminal 112, as illustrated by the solid lines in FIG. 5, and the detection module 11′ is in an “on” state. The placement signal 101′ generated by the detection module 11′ in the “on” state corresponds to a 0-degree predetermined angle. In other words, the projection image 105 produced by the image light beam 104 that is projected by the projection unit 13 and that corresponds to the image output signal 103 is not angularly rotated from the initial orientation. On the other hand, when the projection apparatus 1′ is hung from the ceiling, i.e., in the upturned orientation, the gravitation rod 111 is pivoted at the first end 110 away from the electrical terminal 112 such that the second end 120 is not in electrical connection with the electrical terminal 112, as illustrated by the dotted lines in FIG. 5, and the detection module 11′ is in an “off” state. The placement signal 101′ generated by the detection module 11′ in the “off” state corresponds to a 180-degree predetermined angle. In other words, the projection image 105 produced by the image light beam 104 that is projected by the projection unit 13 and that corresponds to the image output signal 103 is angularly rotated from the initial orientation by 180 degrees.

Other than the gravitation rod 111 of FIG. 5, a ball rolling member, a mercury switch, or a vibration switch is also used in the detection module 11′. However, since operating principles for these detection schemes are known in the art, further details of the same are omitted herein for the sake of brevity.

With the presence of the detection module 11 (11′), the projection apparatus 1 (1′) of the present invention is capable of detecting the placement orientation thereof, and is further capable of adjusting the image source signal 102 automatically so as to orient the projection image 105 produced by the image light beam 104 that corresponds to the image output signal 103 in a way that is upright for viewing by the user, while saving the time and trouble otherwise spent performing manual image adjustments.

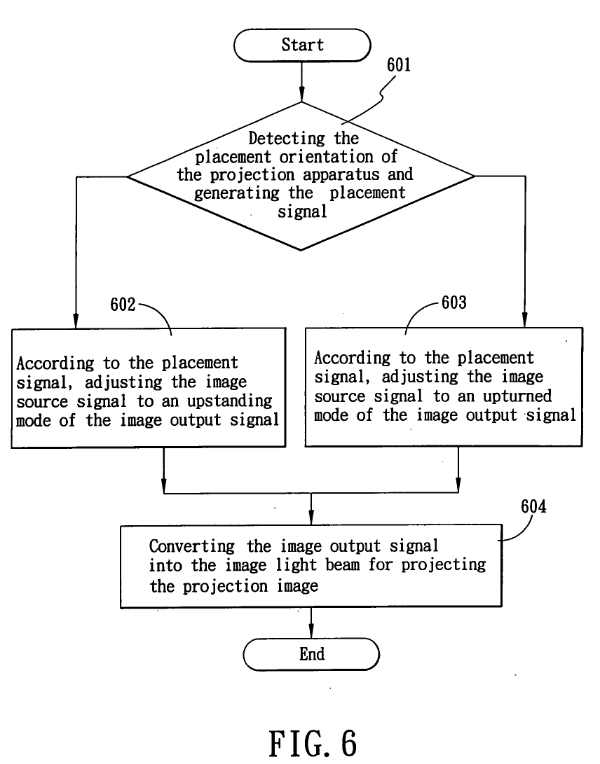

In addition, with reference to FIG. 3 and FIG. 6, the method for automatic image adjustment according to the preferred embodiment that is implemented by the projection apparatus 1 (1′) includes the following steps. First, the placement orientation of the projection apparatus 1 (1′) is detected, and the placement signal 101 (101′) is generated according to the placement orientation thus detected (step 601). The placement orientation of the projection apparatus 1 (1′) is one of the upstanding orientation and the upturned orientation, and is detected using the detection module 11 (11′). Secondly, the image source signal 102 is adjusted by the image processing unit 12 according to the placement signal 101 (101′) to result in the image output signal 103 such that the projection image 105 corresponding to the image output signal 103 is rotated from the initial orientation by a predetermined angle corresponding to the placement signal 101 (101′). In this embodiment, when the placement orientation is the upstanding orientation on the table, the predetermined angle is 0 degrees (i.e., an upstanding mode of the image output signal) (step 602). On the other hand, when the placement orientation is the upturned orientation from the ceiling, the predetermined angle is 180 degrees (i.e., an upturned mode of the image output signal) (step 603). Lastly, the image output signal 103 is converted into the image light beam 104 for projecting the projection image 105 by the projection unit 13 (step 604).

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection apparatus comprising:
a projection unit receiving an image output signal, and converting the image output signal into an image light beam for projecting a projection image;
a detection module detecting a placement orientation of the projection apparatus, and generating a placement signal according to the placement orientation detected thereby; and
an image processing unit coupled to the projection unit and the detection module, and generating the image output signal to the projection unit;
wherein the image processing unit is for receiving an image source signal, and adjusts the image source signal according to the placement signal to result in the image output signal such that the projection image corresponding to the output image signal is rotated from an initial orientation by a predetermined angle.

2. The projection apparatus as claimed in claim 1, wherein the detection module includes:
an accelerometer for detecting the placement orientation of the projection apparatus in terms of angular rotation relative to a pair of axes that are perpendicular to each other, and for generating an analog signal; and
an analog-to-digital converter connected electrically to the accelerometer and the image processing unit, the analog-to-digital converter receiving the analog signal from the accelerometer, and digitizing the analog signal to result in the placement signal.

3. The projection apparatus as claimed in claim 1, wherein the detection module includes a gravitation rod having a first end serving as a pivot, and a second end moving around the first end according to change of the displacement orientation of the projection apparatus, wherein the second end being electrically connected to or disconnected from an electrical terminal according to the movement of the second end so as to generate the placement signal accordingly.

4. The projection apparatus as claimed in claim 1, wherein the placement orientation of the projection apparatus includes an upstanding orientation and an upturned orientation, and the detection module generates a different placement signal for each of the upstanding and upturned orientations.

5. A method of automatic image adjustment for a projection apparatus, comprising the steps of:
(A) detecting placement orientation of the projection apparatus and generating a placement signal according to the placement orientation thus detected;
(B) adjusting an image source signal according to the placement signal to result in an image output signal such that a projection image corresponding to the image output signal is rotated from an initial orientation by a predetermined angle; and
(C) converting the image output signal into an image light beam and projecting a projection image accordingly.

6. The method of automatic image adjustment for a projection apparatus as claimed in claim 5, wherein the placement orientation of the projection apparatus is detected by a detection module.

7. The method of automatic image adjustment for a projection apparatus as claimed in claim 5, wherein adjustment of the image source signal into the image output signal is performed by an image processing unit.

8. The method of automatic image adjustment for a projection apparatus as claimed in claim 5, wherein the image light beam corresponding to the image output signal is projected by a projection unit.

9. The method of automatic image adjustment for a projection apparatus as claimed in claim 5, wherein the placement orientation of the projection apparatus is detected by a detection module to be upstanding or upturned.
